(19) United States
(12) Patent Application Publication
(10) Pub. No.: US 2020/0387850 A1
(43) Pub. Date: Dec. 10, 2020

(54) USING SCORE TIERS TO FACILITATE EVALUATION OF COMPUTER-ASSESSED CANDIDATES FOR EMPLOYMENT PURPOSES

(71) Applicants: Eleanor Kramer, South Jordan, UT (US); Emily Jeppson, South Jordan, UT (US); Lindsey Zuloaga, Salt Lake City, UT (US); Laryn Brown, South Jordan, UT (US); Loren Larsen, Lindon, UT (US)

(72) Inventors: Eleanor Kramer, South Jordan, UT (US); Emily Jeppson, South Jordan, UT (US); Lindsey Zuloaga, Salt Lake City, UT (US); Laryn Brown, South Jordan, UT (US); Loren Larsen, Lindon, UT (US)

(21) Appl. No.: 16/891,941

(22) Filed: Jun. 3, 2020

Related U.S. Application Data
(60) Provisional application No. 62/857,135, filed on Jun. 4, 2019.

(51) Int. Cl. G06Q 10/06; G06Q 10/10; G06N 3/04; G06N 3/08; G06N 20/00

(52) U.S. Cl. CPC G06Q 10/06393; G06Q 10/06398; G06N 20/00; G06N 3/0454; G06N 3/08; G06Q 10/1053

(57) ABSTRACT

A processing device is to: receive a request to create a tiered evaluation comprising a plurality of tiers to group candidates by competency; generate a first tier of the plurality of tiers with a first criteria comprising a first range of assessment scores; send a first candidate assessment; receive first assessment data of the first candidate profile captured during the first candidate assessment; generate a first assessment score associated with the first candidate profile from the first assessment data; determine that the first candidate profile satisfies the first criteria by at least determining that the first range of assessment scores comprises the first assessment score; responsive to determining that the first candidate profile satisfies the first criteria, place the first candidate profile in the first tier; and send tiered assessment data comprising the first tier with the first candidate profile.

### RELATED APPLICATION

This application claims the benefit of U.S. Provisional Application No. 62/857,135, filed Jun. 4, 2019, the entire contents of which are incorporated herein by reference.

### BACKGROUND

Finding and hiring employees is a task that impacts most modern businesses. An employer seeks to find employees that “fit” open positions. The processes associated with finding employees that fit well can be expensive and time consuming for an employer. Such processes may include evaluating numerous resumes and cover letters, telephone interviews with candidates, in-person interviews with candidates, drug testing, skill testing, sending rejection letters, offer negotiation, training new employees, etc. Before a hiring decision is made, evaluation and interaction with each employee candidate may be very costly in terms of man-hours. One technique that has been used to better optimize the hiring process is the use of pre-hire assessments.

Validated pre-hire assessments—those that are designed around specific jobs and job-related competencies—gained wide use in the 1970s. Assessments were most often taken at designated testing centers and usually took the form of a long multiple-choice questionnaire or test.

Through the decades, these multiple-choice assessment tests were transcribed onto the new technologies of the time. Up until the early 2010s, pre-hire assessments remained largely the same, e.g., a multiple-choice, closed-ended test. All that changed was the modality: over the phone, on a PC, over the internet, etc. These assessments were the same legacy tests simply delivered in a different way. They were long, boring, and did not make for a great experience for anyone involved in the hiring process.

Today's technology is revolutionizing the concept of pre-hire assessment. They can be a quicker, more engaging experience, yet just as predictive as legacy pre-hire assessments.

The subject matter claimed herein is not limited to embodiments that solve any disadvantages or that operate only in environments such as those described above. Rather, this background is only provided to illustrate one exemplary technology area where some embodiments described herein may be practiced. Namely, the present disclosure may also be applied in other societal determinations such as benefits determinations, zoning, credit, voting, and the like.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 is a block diagram of an exemplary network architecture in which embodiments of a candidate assessment platform may operate.

FIG. 2 is a flow diagram of a method for assessing candidates using tiers, according to some embodiments.

FIG. 3 shows a candidate assessment platform interface, according to some embodiments.

FIG. 4 shows a candidate assessment platform interface with video assessment, according to some embodiments

FIG. 5 shows a candidate assessment platform interface, according to some embodiments.

FIG. 6 show exemplary criteria for a candidate assessment platform.

FIG. 7 illustrates a diagrammatic representation of an exemplary computing device in which embodiments of a candidate assessment platform may operate.

### DETAILED DESCRIPTION

Methods and systems for using score tiers to facilitate evaluation on automatically assessed candidates for employment purposes are described. In the following description, numerous details are set forth. The methods and systems may be used in pre-hire assessment platforms, as well as other digital evaluation platforms, to predict the likelihood of candidates being hired.

Conventionally, candidates who have participated in an automated assessment were only stack ranked based on their raw scores, limiting the ability of evaluators and others to discover the boundaries between top talent and less qualified candidates. When evaluating candidates for employment, it is advantageous to be able to automatically categorize candidates based on their performance in an automated assessment. These categorizations or scoring tiers are used to improve the efficiency of the selection process, reducing evaluator effort and thus time to hire.

The automated assessment, categorization, and/or generation of scoring tiers may be carried out on a hiring platform (such as HireVue's Platform of South Jordan, Utah) that includes one or more web server (or other computing device), web-based application programming interfaces (APIs), hardware integration with microphones, video cameras, scheduling software, and other such services provided by software and integrated across the hiring platform. Such integration may further include and is not limited to integration with mobile applications, telephone/video services, and other software and hardware-based systems that collect data, including video interviews, informational assessments, and the like. The hiring platform may further include the processing power and means to organize and analyze collected data with artificial intelligence such as machine learning models and algorithms, e.g., labeled data algorithm, classification algorithm, tree-structured classifier, regression algorithm, association algorithm, ensemble algorithm, supervised learning, support vector machine (SVM) algorithm, neural networks, deep neural networks, decision trees, Naive Bayes, nearest neighbor, unsupervised learning, semi-supervised learning, reinforced learning, ensemble, and the like.

In addition, Industrial Organizational (I/O) Psychologists may contribute to organization of the scoring tier groups, which are pools of candidates that can be compared against each other. By establishing the appropriate score range and scoring tier group, the I/O Psychologists can prevent adverse impact or bias against any protected class and verify that the appropriate pool of candidates are being used for comparison.

Another embodiment, the disclosed platform may uses automated processes to auto-configure the appropriate scoring tiers based on maximizing candidate quality while minimizing adverse impact to protected classes. An example of this includes the platform determining that the lowest score tier range needs to be set to a particular range and updating the platform during a digital assessment publishing process.

With auto-configured scoring tiers, the platform can configure scoring tiers to re-categorize candidates based on various criteria, such as the number of remaining positions to be filled, or alternatively, promoting candidates who have been in the pool for shorter or longer periods than others. In another embodiment, the platform can configure scoring tiers to re-categorize candidates based on status information. For example a tier can be more or less inclusive due to changing circumstances related to the position or candidate profiles. Finally, the platform may promote or remove candidates from scoring tiers based on a predetermined desired diversity composition. These re-categorizations can override the basic score based heuristic, assuring that desired candidates are included in each tier.

Additionally, the platform can optimize the scoring tiers for other targets, including validity testing. For example, the platform can inject unrecommended people into the tier to see how the independent human evaluator views these or adding candidates to tiers based on how they would rate at other companies.

Once a position has been appropriately configured, a candidate can be asked to take an automated assessment. This assessment may comprise video or audio responses to interview questions, essay responses to interview questions, multiple choice or other written responses, resume analysis, game play results, or the like. The automated assessment produces a raw score that can function as an evaluation of proficiency as compared to a standard. An example standard can be a certain percentage match to a success profile comprised of various competency, performance, and skill measures that the automated assessment measures. The generated score can be used to determine a list of candidates that performed in similar ways within an established range of responses. This list can be assigned a scoring tier.

In an embodiment, the platform may facilitate one or more behaviors by user after a scoring tier has been assigned. For example, the platform may carry out independent human evaluation of candidates applying for a similar employment position including focusing the evaluators on the tiers that they wish to review first. In another example, the platform may sort within each scoring tier, enable a stack ranking of candidates within the tier, randomize the profiles within each tier, sort the profiles by timestamp within each tier, or sort by independent human evaluator rating within each tier. In another example, the platform may promote or dispose of candidates profiles based on their score tiers with no human evaluation, or based on a previously established set of rules. In another example, the platform may include generating reports (both on the platform and as downloadable files) that display the scoring tiers and allow for independent evaluation of candidates outside the platform In another example, the platform may integrate with third party Applicant Tracking Systems and share the scoring tiers with these record systems for additional action by the customer. In another example, the platform may include the use of public APIs to access scoring tiers via third parties for additional action by the customer. In another example, the platform may use mobile apps, mobile web, and desktop access points to the platform to view and interact with the scoring tiers.

The platform may represent scoring tiers in many ways. For example, the platform may represent the scoring tiers as labeled groups of candidate interviews grouped by scoring tier. For example, once a candidate profile receives a score and placed in a tier, a label associated with the tier may be attached to the profile. In another example, the platform can represent the scoring tiers as textual labels in various charts, graphs, or downloadable files, e.g. Top tier, Gold medalist, Exceptional, or the like. In another example, the platform can represent the scoring tiers as colors, e.g. as gold, silver, bronze, or the like. In another example, the platform can represent scoring tiers as icons, badges or other visual elements.

Scoring tiers can have many applications for many scenarios. For example, the platform can use scoring tiers to compare candidates applying for the same position at a company. In another example, the platform can use scoring tiers to compare candidates that have applied for multiple positions within a company. In another example the platform can use scoring tiers to compare internal candidates for a position (e.g. internal mobility). In another example, the platform can use scoring tiers to compare candidates from a graduate/campus hiring event in real time or after the event has concluded. In another example, the platform can use scoring tiers to enable manual review of applicants who do not successfully complete an assessment due to any reason. For example, the candidate may experience technical issues with audio, video, internet access, or computer issues. In another example, the candidate can opt out of assessments due to General Data Protection Regulation (GDPR) or other privacy concerns. In another example, the candidate can opt out of assessments due to a disability or accommodation request.

Scoring tiers can allow users to efficiently group similar candidates and perform actions on that group using manual or automated processes. In addition, scoring tiers allow those candidates who did not complete their assessment to be highlighted for the appropriate next action, including manual review of their assessment results. This improves the efficiency of the selection process, reducing evaluator effort and thus time to hire.

The platform can use scoring tiers as a mechanism for filtering and matching candidates to multiple positions across more than one company. For example, a candidate can take an assessment and then be routed to the most appropriate job opening across multiple companies. Scoring tiers can allow for categorizing and filtering the candidates that best match the criteria of the hiring company, only promoting the best matched candidate to their position.

Pre-hire assessments differ from other employee selection methods (interviewing, resume screening, or the like) by factors such as scale and validation. For example, a single recruiter may not be able to consistently and objectively screen thousands of applicants. However, a pre-hire assessment can provide a consistently objective evaluation that can be deployed on a large scale.

Validation can include the process by which a selection system is shown to reliably and consistently support valid inference that relate to and predict job-related outcomes and behaviors. A validated assessment may include evidence to support how job-related behaviors or characteristics are measured, what is measured, and how that measurement process relates to valued outcomes, such as on-the-job performance, core competency behaviors, retention and the like. The platform may statistically correlate scores to the attribute the assessment is trying to measure. For example, a requested attribute may be to predict job performance, the platform may compare assessment scores of past candidates to new hires' performance data.

The world of work can be more complex than ever before. Entry-level hourly jobs can require a unique combination of job-related competencies. Cognitive ability (General Mental Ability (GMA)) can be a good predictor of job success. For example, emotional intelligence, communication skills, and various personality traits can also be critical for success on the job.

Legacy pre-hire assessments do not allow for the comprehensive measurement of job-relevant competencies in an efficient, candidate friendly manner. To evaluate candidates on a range of job relevant competencies and attributes legacy pre-hire assessment need several tests to be administered to get a comprehensive evaluation of a candidate's employability. For example, a test that measures personality traits won't measure cognitive ability or job-specific competencies; and a cognitive ability test won't give insight into personality or technical competencies. To evaluate candidates on a range of relevant competencies and traits using legacy assessments, several tests need to be administered—sometimes referred as a test battery. Getting a complete evaluation of a candidate like this is unworkable for most roles. To gather enough data for a comprehensive, validated evaluation of a candidate, hours of testing would be required.

Today's technology can finally move beyond the legacy multiple-choice test and deliver assessments in an expedited, candidate-friendly delivery modality. Rather than putting a candidate through an hour or more of testing, a pre-hire assessment may evaluate a candidate's employability, which may include the optimal combination of personality traits, cognitive ability, and competency areas for a target set of job roles, in some embodiments 30 minutes.

The candidate assessment may comprise artificial intelligence power video-based and game-based assessment. In one embodiment artificial intelligence can be used to transform OnDemand video interview into a scored assessment that can reduce bias and augment talent decisions at scale.

A short video can comprise over thousands of data points where a legacy multiple choice assessment might only provide a data point per question. The data in a video interview can be the same data parsed in a traditional interview. For example, the assessment can evaluate the content of the speech, for example what the candidate says. In another example, the assessment can evaluate the intonation, inflection, and other audio cues by how the candidate speaks. In another example, the assessment can evaluate the emotions a candidate portrays, particularly in relation to what is being said at the time and by what the candidate does while they speak. The assessment can combine leading-edge data science with I/O Psychology to generate an accurate assessment.

In some embodiments, the platform predetermines the questions candidates answer. The platform may create questions to elicit responses predictive of job success. For example, questions may show situational judgement, be scenario-based, and reveal past behavior. In another embodiment, the platform may craft questions to elicit candidates to exhibit behavior relevant to job performance. For example, the questions can simulate communicating with team members through a video response.

In some embodiments, video based assessment can statistically link the video data from recorded interviews to job performance data and/or competencies. In some embodiments, the platform may create an algorithm to analyze the interviews relevant for each job role. The algorithm may undergo full validation testing, as well as adverse impact mitigation. For example, the platform can remove from consideration any data that contributes to adverse impact without significantly impacting the assessment's accuracy. A video based assessment combined with artificial intelligence may provide insight into attributes like social intelligence (interpersonal skills), communication skills, personality traits, and overall job aptitude.

In some embodiments, the assessment may include a game-based assessment. Game-based assessments may comprise one or more short psychometric games. Each game can take a few minutes to complete, and different games can be associated with a range of cognitive skills, including numeracy, problem-solving, attention, and the like. Each of these skills can be related to a fluid Intelligence Quotient (IQ), or how well an individual processes completely new information. A complete game-based assessment may involve a battery of different games, and in some embodiments may only take 6-15 minutes to complete.

In some embodiments, games can collect a number of different data types. For example, the platform can measure actual game performance. Additionally, the platform may record taps, swipes, and pauses can provide insight into a candidate's thinking and problem-solving. The games may be dynamically progressive, or adapt in real time based on a candidate's performance. For example, if a candidate successfully completes a task in a game, the next task they will be asked to complete will be more difficult. In another example, if the candidate struggles and fails a task, they will be given an easier task the next time.

In some embodiments, game-based assessments can work by statistically linking this data gathered during gameplay to job performance data and/or competencies. The platform may create an algorithm to analyze the data. The platform may validate the algorithm against accepted measures of cognitive ability, as well as the job performance data and/or competencies. Similar to some embodiments of video interviews, some embodiments of game-based assessment may go through a comprehensive process to mitigate adverse impact.

In some embodiments, the assessment may comprise both a video-based assessment and a games-based assessment. For example, the video-based assessment may focus on measuring emotional and social aptitudes like interpersonal skills, communication skills, and personality traits. The games-based assessment may focus on measuring cognitive aptitudes like fluid IQ, visuospatial reasoning, and memory.

In some embodiments, the assessment may be customized. Custom assessment may be built around a job's specific performance data in a single organization. Custom assessments can be organization-specific, and designed to evaluate the competencies that uniquely lead to success. Custom assessments can be video-based, game-based, or a combination of the two. They can also be combined with coding challenges to provide a comprehensive assessment for technical roles.

In some embodiment, questions in a custom-video assessment can be unique for each organization based on the findings that emerge from a job analysis. The questions can be designed to elicit responses predictive of job performance. Every assessment may have a unique question set. Likewise, game-based challenges can be chosen based on the unique competencies identified as crucial for success. In some embodiments, custom assessment may require job analysis and minimum number of employees with matching performance data for algorithm build and launch. The implementation timeline of a custom assessment may be based on the ability to collect data related to desired outcomes.

In some embodiments, the assessment can be pre-built and driven by artificial intelligence. Job-specific pre-built assessments can use a combination of video-based interview questions, game-based challenges, and—for other relevant technical roles—coding challenges to measure job related competencies and knowledge domains. In some embodiments, pre-built game-based cognitive assessments can use game-based challenges to measure cognitive ability exclusively.

Pre-built assessments can be built around common job roles to evaluate the competencies identified as critical to job success, and can be configured for fast deployment after a job analysis confirms the assessment is a good match for a particular role.

Pre-built assessments can be pre-built with thoroughly researched standard questions and competency-based algorithms indicative of job success across specific jobs. Pre-built assessment may require detailed scoping and job analysis to ensure the competencies and questions are job-related before launch. Pre-built assessments can include video-based, game-based, and coding challenges. Pre-built assessment can be configured for fast deployment.

In some embodiments, organizations may begin with a pre-built assessment, and then transition to custom predictive algorithms built around their specific performance data and outcomes. This may allow recruiting teams to kick start artificial intelligence (AI) driven assessment with pre-built algorithms for a quicker launch while still gaining the organization specific insight that comes from a custom algorithm built over time.

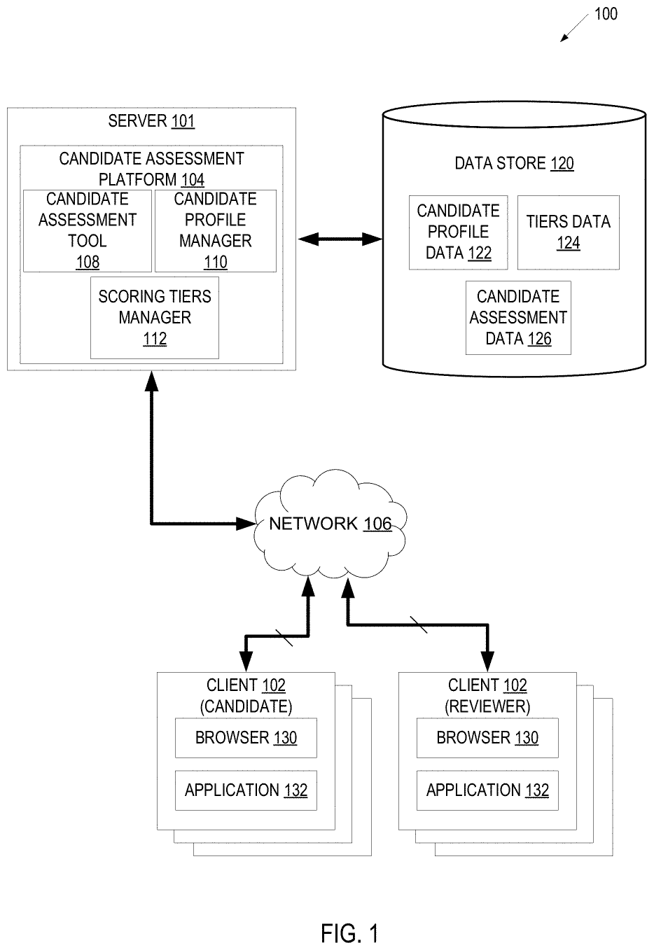

FIG. 1 is a block diagram of an example of a network architecture 100 in which embodiments of a candidate assessment platform 104 may operate. The illustrated network architecture 100 may include multiple client 102 coupled to a server computing system 101 via a network 106 (e.g. public network such as the Internet or private network such as a local area network (LAN)). The network 106 may include the Internet and network connections to the Internet. Alternatively, the server computing system 101 and the client 102 may be located on a common Local Area Network (LAN), Personal area network (PAN), Campus Area Network (CAN), Metropolitan area network (MAN), Wide area network (WAN), wireless local area network, cellular network, virtual area network, or the like.

In various embodiments, the server computing system 101 may include on or more machines (e.g., one or more server computer systems, routers, gateways) that have processing and storage capabilities to provide functionality described herein. The server computing system 101 may execute a candidate assessment platform 104. The candidate assessment platform 104 may perform various function as described herein and may include a candidate assessment tool 108, a candidate profile manager 110, and a scoring tiers manager 112 for tracing, assessing, and evaluating candidates for a position, such as the candidate assessment platform developed by HireVue, Inc.

The client 102 may be a client workstation, a server, a computer, a portable electronic device, an entertainment system configured to communicate over a network, such as a set-top box, a digital receiver, a digital television, a mobile phone, a smart phone, a tablet, or other electronic devices. For example, portable electronic device may include, but are not limited to, cellular phones, portable gaming systems, portable computing devices or the like. The client 102 may have access to the Internet via a firewall, a router or other packet switching devices. The clients 102 may connect to the server computing system 101 through one or more intervening devices, such as routers, gateways, or other devices. The clients 102 are variously configured with different functionality and may include a browser 130 and one or more applications 132. In one embodiment, the clients 102 accesses the candidate assessment platform 104 via the browser 130 and the candidate assessment platform 104 is a web-based application or a cloud computing system that presents user interfaces to the client 102 via the browser 130. Similarly, one of the applications 132 may be used to access the candidate assessment platform 104. For example, a mobile application (referred to as “app”) may be used to access one or more user interfaces of the candidate assessment platform 104.

In various embodiments, the candidate assessment platform 104 may be one or more software products that facilitates the pre-hire assessment process. For example, in some cases, the client 102 is used by a candidate to conduct candidate assessment. Candidate assessment platform 104 may capture candidate assessment data 126 and candidate profile data 122 from the candidate and store the data in a data store 120. The candidate profile data 122 and the candidate assessment data 126 may include information uploaded by the candidate, audio information captured during an assessment, video information captured during the assessment, game play data captured during gaming, information submitted by the candidate before or after the assessment, and data collected for the candidate after hiring. The client 102 may also be used by a reviewer to review, screen, and select candidates. The reviewer may access the candidate assessment platform 104 via the browser 130 or the application 132 as described above. Candidate assessment platform 104 may be activated by the reviewer (or automatically activated when enabled) to upload performance data for a candidate, screening a list of candidates, or for other reviewing purposes, as described herein.

The data store 120 may represent one or more data repositories on one or more memory devices. The data store 120 may be a database or any other organized collection of data. The data store 120 may store the candidate profile data 122, scoring tiers data 124, and candidate assessment data 126. For example, the data store 120 may include general computer storage.

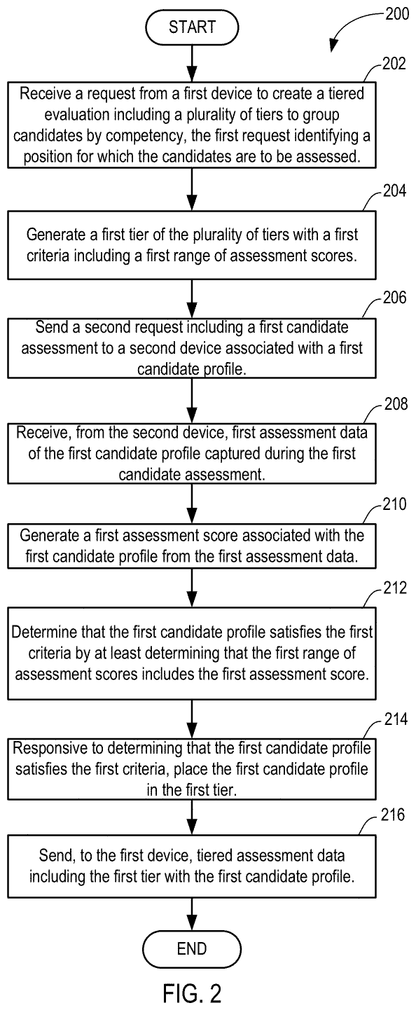

FIG. 2 is a flow diagram of a method 200 for assessing candidates using tiers, according to some embodiments described herein. Some operations of method 200 may be performed by processing logic that may include hardware (circuitry, dedicated logic, etc.), software (such as is run on a general purpose computer system or a dedicated machine), firmware, or some combination thereof. Some operations of method 200 may be performed by a computing device, such as the server computing system 101 of FIG. 1. For example, processing logic that performs one or more operations of method 200 may execute on the server computing system 101 or on other computing devices of the network architecture 100.

At operation 202, the processing logic receives a request from a device to create a tiered evaluation including a plurality of tiers to group candidates by competency. The first request may identify a position for which the candidates are to be assessed. At operation 204, the processing logic generates a first tier of the plurality of tiers with a first criteria including a first range of assessment scores. At operation 206, the processing logic sends a first candidate assessment to a second device associated with a first candidate profile. At operation 208, the processing logic receives, from the second device, first assessment data of the first candidate profile captured during the first candidate assessment. At operation 210, the processing logic generates a first assessment score associated with the first candidate profile from the first assessment data. At operation 212, the processing logic determines that the first candidate profile satisfies the first criteria by at least determining that the first range of assessment scores includes the first assessment score. At operation 214, the processing logic, responsive to determining that the first candidate profile satisfies the first criteria, places the first candidate profile in the first tier. At operation 216, the processing logic sends, to the first device, tiered assessment data that includes the first tier with the first candidate profile.

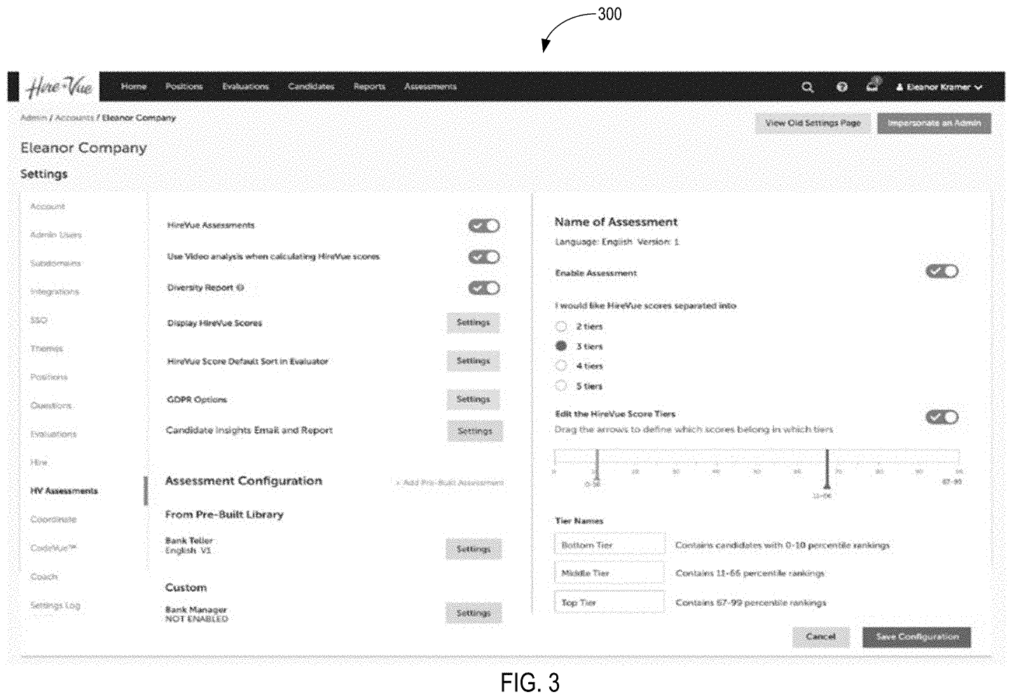

FIG. 3 shows a candidate assessment platform interface 300, according to some embodiments. As seen in FIG. 3, the scoring tier can be configurable in several ways. The total number of tiers can be configured, e.g., from tier 2 to tier 100. The name of each tier can be established, e.g., Top tier, Gold medalist, Exceptional, and the like. The range (e.g., a scoring range) of each tier can be defined, dividing up the overall score range to fit into each scoring tier. In addition, visibility into the scoring tiers can be configurable by user role, allowing some users to see the scoring tiers while others would not have access to this information.

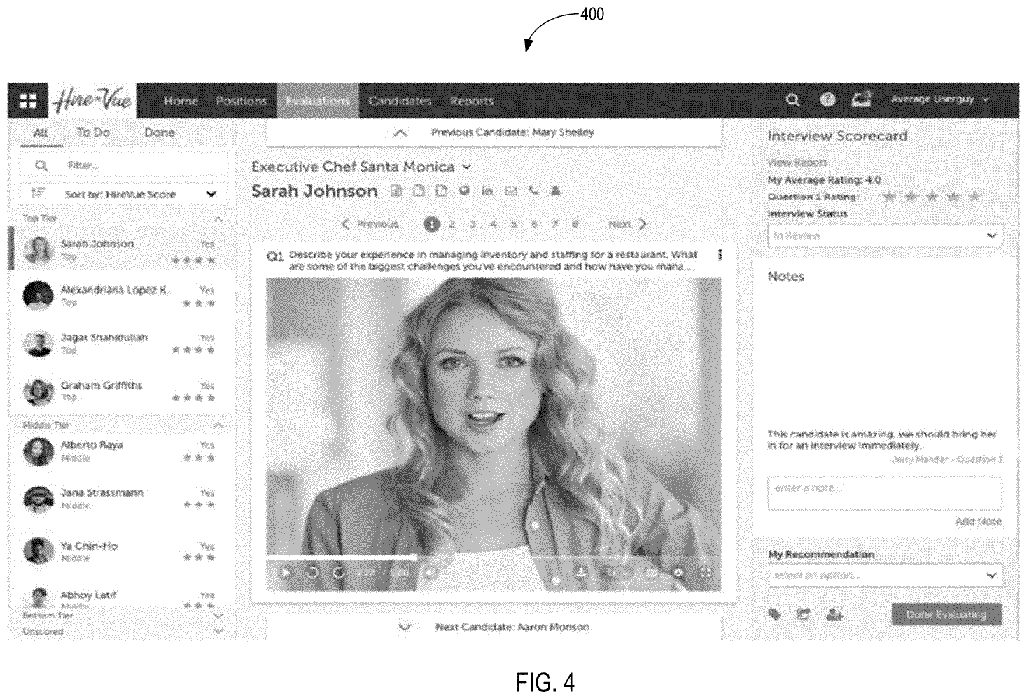

FIG. 4 shows a candidate assessment platform interface with a video assessment 400, according to some embodiments. As seen in FIG. 4, video interviews can be asynchronous. Candidates can record their responses to interview questions at the time of their choosing, and can be compatible on any device. Recruiters and hiring managers can review candidates' interviews side-by-side at any time. In some embodiments the recorded interview can be 15-20 minutes long.

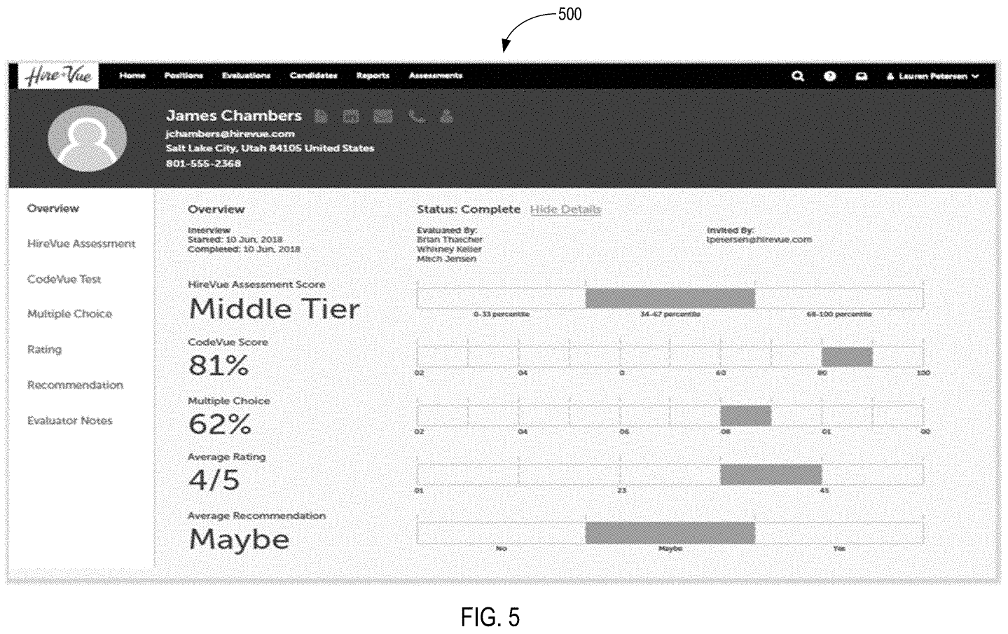

FIG. 5 shows a candidate assessment platform interface 500, according to some embodiments. As seen in FIG. 5, when a candidate has completed an assessment, the platform can evaluate the responses by applying an algorithm and giving a raw score. Then, based on the above configuration and their raw score, the platform can place the scored candidate in the appropriate score tier and assign a score tier label (e.g., Top tier, Middle tier, Bottom tier, and the like).

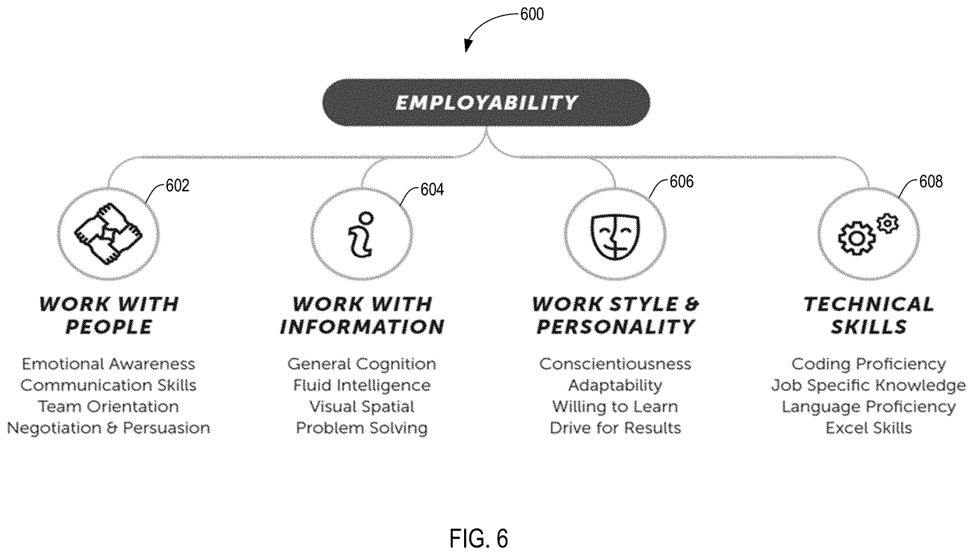

FIG. 6 shows exemplary employability criteria 600 for a candidate assessment platform according to some embodiments. The platform may include exemplary employability criteria 600 that can be critical for job effectiveness. For example, the platform may evaluate a candidate's ability to work with people 602 which may include the extent to which the candidate can form productive and rewarding relationships with others. In another example, the platform may evaluate a candidate's ability to work with information 604 which may include the extent to which the candidate has the cognitive abilities to effectively process information and data they encounter in the role to drive decisions and action. In another example, the platform may evaluate a candidate's working style and personality 606 which may include the extent to which candidate has the right level and mix of personality, motivation, and attitudes to meet the people, data, and information demands of the job. In another example, the platform may evaluate a candidate's specific knowledge and technical skills 608 which may include the extent to which the candidate has job specific knowledge and skills required for effective performance in a role.

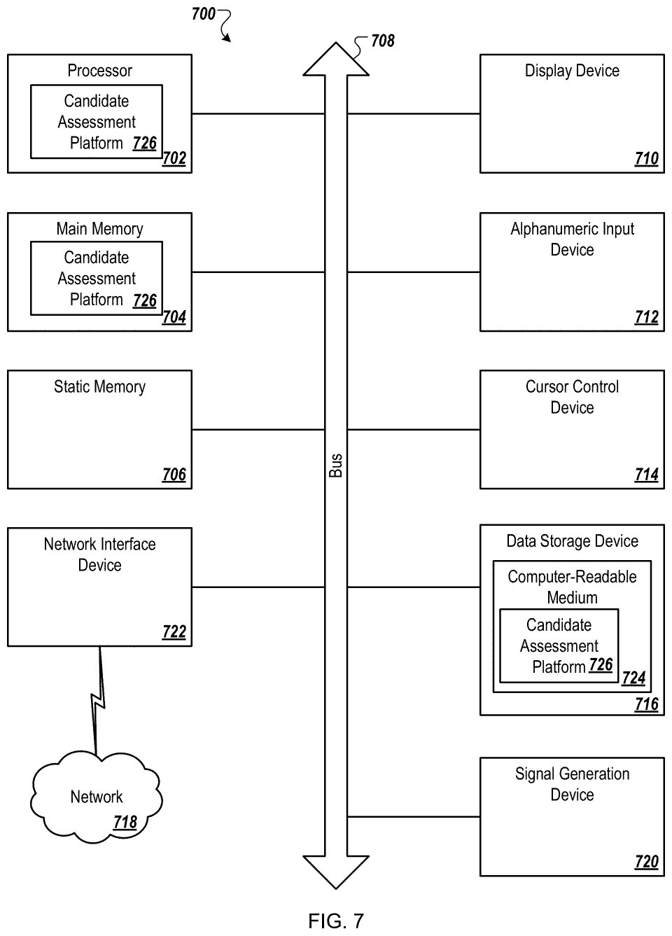

FIG. 7 illustrates a diagrammatic representation of an exemplary computing system 700 in which embodiments of a candidate assessment platform 104 may operate. Within the computing system 700 is a set of instructions for causing the machine to perform any one or more of the methodologies discussed herein. In alternative embodiments, the machine may be connected (e.g., networked) to other machines in a LAN, an intranet, an extranet, or the Internet. The machine may operate in the capacity of a server or a client machine in a client-server network environment, or as a peer machine in a peer-to-peer (or distributed) network environment. The machine may be a PC, a tablet PC, a set-top-box (STB), a personal data assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein for a candidate assessment platform for assessing candidates and the like, such as the method 200 described above. In one embodiment, the computing system 700 represents various components that may be implemented in the server computing system 101 as described above. Alternatively, the server computing system 101 may include more or less components as illustrated in the computing system 700.

The exemplary computing system 700 includes a processing device 702, a main memory 704 (e.g., read-only memory (ROM), flash memory, dynamic random access memory (DRAM) such as synchronous DRAM (SDRAM), etc.), a static memory 706 (e.g., flash memory, static random access memory (SRAM), etc.), and a data storage device 716, each of which communicate with each other via a bus 708.

Processing device 702 represents one or more general-purpose processing devices such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 702 may also be one or more special-purpose processing devices such as an application specific integrated circuit (ASIC), a field programmable gate array (FPGA), a digital signal processor (DSP), network processor, or the like. The processing device 702 is configured to execute the processing logic or instructions (e.g., candidate assessment platform 726) for performing the operations and steps discussed herein.

The computing system 700 may further include a network interface device 722. The computing system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 720 (e.g., a speaker).

The data storage device 716 may include a computer-readable non-transitory storage medium 724 on which is stored one or more sets of executable instructions (e.g., candidate assessment platform 726) embodying any one or more of the methodologies or functions described herein. The candidate assessment platform 726 may also reside, completely or at least partially, within the main memory 704 and/or within the processing device 702 during execution thereof by the computing system 700, the main memory 704 and the processing device 702 also constituting computer-readable storage media. The candidate assessment platform 726 may further be transmitted or received over a network via the network interface device 722.

While the computer-readable non-transitory storage medium 724 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing a set of instructions for execution by the machine and that causes the machine to perform any one or more of the methodologies of the present embodiments. The term “computer-readable storage medium” shall accordingly be taken to include, but not be limited to, solid-state memories, optical media, magnetic media or other types of mediums for storing the instructions. The term “computer-readable transmission medium” shall be taken to include any medium that is capable of transmitting a set of instructions for execution by the machine to cause the machine to perform any one or more of the methodologies of the present embodiments.

The candidate assessment platform 726, components, and other features described herein may be implemented as discrete hardware components or integrated in the functionality of hardware components such as ASICs, FPGAs, DSPs, or similar devices. The candidate assessment platform 726 may implement operations of performance model adverse impact correction as described herein. In addition, the candidate assessment platform 726 may be implemented as firmware or functional circuitry within hardware devices. Further, the candidate assessment platform 726 may be implemented in any combination hardware devices and software components.

Some portions of the detailed description above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving,” “generating,” “communicating,” “capturing,” “executing,” “defining,” “specifying,” “creating,” “recreating,” “processing,” “providing,” “computing,” “calculating,” “determining,” “displaying,” or the like, refer to the actions and processes of a computing system, or similar electronic computing systems, that manipulates and transforms data represented as physical (e.g., electronic) quantities within the computing system's registers and memories into other data similarly represented as physical quantities within the computing system memories or registers or other such information storage, transmission or display devices.

Embodiments of the present invention also relate to an apparatus for performing the operations herein. This apparatus can be specially constructed for the required purposes, or it can comprise a general-purpose computing system specifically programmed by a computer program stored in the computing system. Such a computer program can be stored in a computer-readable storage medium, such as, but not limited to, any type of disk including optical disks, compact discs read-only memory (CD-ROMs), and magnetic-optical disks, read-only memories (ROMs), random access memories (RAMs), erasable programmable read-only memory (EPROMs), electrically erasable programmable read-only memory (EEPROMs), magnetic or optical cards, or any type of media suitable for storing electronic instructions.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to utilize the invention and various embodiments with various modifications as may be suited to the particular use contemplated.

What is claimed is:

1. A server comprising:
a computer storage; and
a processing device coupled to the computer storage, the processing device to:
receive a request from a first device to create a tiered evaluation comprising a plurality of tiers to group candidates by competency, the request identifying a position for which the candidates are to be assessed;
generate a first tier of the plurality of tiers with a first criteria comprising a first range of assessment scores;
send a first candidate assessment to a second device associated with a first candidate profile;
receive, from the second device, first assessment data of the first candidate profile captured during the first candidate assessment;
generate a first assessment score associated with the first candidate profile from the first assessment data;
determine that the first candidate profile satisfies the first criteria by at least determining that the first range of assessment scores comprises the first assessment score;
responsive to determining that the first candidate profile satisfies the first criteria, place the first candidate profile in the first tier; and
send, to the first device, tiered assessment data comprising the first tier with the first candidate profile.

2. The server of claim 1, wherein the processing device is further to:
generate a second tier of the plurality of tiers with a second criteria comprising a second range of assessment scores;
send a second candidate assessment to a third device associated with a second candidate profile;
receive, from the third device, second assessment data of the second candidate profile captured during the second candidate assessment;
generate a second assessment score associated with the second candidate profile from the second assessment data;
determine that the second candidate profile satisfies the second criteria by at least determining that the second range of assessment scores comprises the second assessment score; and
responsive to determining that the second candidate profile satisfies the second criteria, place the second candidate profile in the second tier, wherein the tiered assessment data further comprises the second tier with the second candidate profile.

3. The server of claim 2, wherein the first candidate profile comprises one or more attributes of the first candidate and the processing device is further to:
receive third criteria comprising a requested attribute of a candidate;
determine the first candidate profile satisfies the third criteria by at least determining that the first candidate profile comprises the requested attribute; and
responsive to determining the first candidate profile satisfies the third criteria, remove the first candidate profile from the first tier and place the first candidate profile in the second tier.

4. The server of claim 1, wherein the processing device is further to:
receive status information related to the position;
in response to receiving the status information, alter the first criteria by changing the first range of assessment scores to a second range of assessment scores wherein, the second range of assessment scores is less inclusive than the first range of assessment scores;
determine the second range of assessment scores does not comprise the first assessment score; and
responsive to determining the second range of assessment scores does not comprise the first assessment score, remove the first candidate profile from the first tier.

5. The server of claim 1, wherein the request comprises a number of tiers to be generated in the tiered evaluation.

6. The server of claim 1, wherein the request further comprises a plurality of labels to be associated with the plurality of tiers, and wherein the processing device is further to:
attach a first label of the plurality of labels to the first tier; and
wherein, to place the first candidate profile in the first tier, the processing device is further to assign the first label to the first candidate profile.

7. The server of claim 1, wherein to generate the first tier of the plurality of tiers, the processing device is further to generate the first range of assessment scores using a machine learning model to correlate competency scores of past candidates with hiring results for the past candidates.

8. The server of claim 7, wherein the processing device further trains the machine learning model to generate the first range of assessment scores using at least one or a combination of a support vector machine, a regression algorithm, a neural network, a tree-structured classifier, or an ensemble algorithm.

9. A method comprising:
receiving, by a processing device from a first device, a request to create a tiered evaluation comprising a plurality of tiers to group candidates by competency, the request identifying a position for which the candidates are to be assessed;
generating, by the processing device, a first tier of the plurality of tiers with a first criteria that comprises a first range of assessment scores;
sending, by the processing device, a first candidate assessment to a second device associated with a first candidate profile;
receiving, by the processing device from the second device, first assessment data of the first candidate profile captured during the first candidate assessment;
generating, by the processing device, a first assessment score associated with the first candidate profile from the first assessment data;
determining, by the processing device, that the first candidate profile satisfies the first criteria by at least determining that the first range of assessment scores comprises the first assessment score;
responsive to determining that the first candidate profile satisfies the first criteria, placing, by the processing device, the first candidate profile in the first tier; and
sending, by the processing device to the first device, tiered assessment data comprising the first tier with the first candidate profile.

10. The method of claim 9, further comprising:
generating, by the processing device, a second tier of the plurality of tiers with a second criteria that comprises a second range of assessment scores;
sending, by the processing device to a third device, a second candidate assessment associated with a second candidate profile;
receiving, by the processing device from the third device, second assessment data of the second candidate profile captured during the second candidate assessment;
generating, by the processing device, a second assessment score associated with the second candidate profile from the second assessment data;
determining, by the processing device, that the second candidate profile satisfies the second criteria by at least determining that the second range of assessment scores comprises the second assessment score; and
responsive to determining that the second candidate profile satisfies the second criteria, placing, by the processing device, the second candidate profile in the second tier,
wherein the tiered assessment data further comprises the second tier with the second candidate profile.

11. The method of claim 10 further comprising:
receiving, by the processing device, third criteria comprising a requested attribute of a candidate;
determining, by the processing device, that the first candidate profile satisfies the third criteria by at least determining that the first candidate profile comprises the requested attribute, wherein the first candidate profile comprises one or more attributes of the first candidate; and
responsive to determining the first candidate profile comprises the requested attribute, removing the first candidate profile from the first tier and placing the first candidate profile in the second tier.

12. The method of claim 9 further comprising:
receiving status information related to the position;
responsive to receiving the status information, altering the first criteria by changing the first range of assessment scores to a second range of assessment scores wherein the second range of assessment scores is less inclusive than the first range of assessment scores;
determining the second range of assessment scores does not comprise the first assessment score; and
responsive to determining the second range of assessment scores does not comprise the first assessment score, removing the first candidate profile from the first tier.

13. The method of claim 9, wherein the request comprises a number of tiers to be generated in the tiered evaluation.

14. The method of claim 9 further comprising:
attaching a first label of a plurality of labels to the first tier, wherein the request further comprises the plurality of labels to be associated with the plurality of tiers; and
wherein assigning the first candidates profile to the first tier further comprises assigning the first label to the first candidate profile.

15. The method of claim 9, wherein generating the first tier of the plurality of tiers, the processing device is further to generate the first range of assessment scores using a machine learning model to correlate competency scores of past candidates with hiring results for the past candidates.

16. The method of claim 15, wherein the processing device further trains the machine learning model to generate the first range of assessment scores at least one or a combination of a support vector machine, a regression algorithm, a neural network, a tree-structured classifier, or an ensemble algorithm.

17. A computer-readable non-transitory storage medium comprising executable instructions to cause a processing device to:
receiving, from a first device, a request to create a tiered evaluation comprising a plurality of tiers to group candidates by competency, the request identifying a position for which the candidates are to be assessed;
generating a first tier of the plurality of tiers with a first criteria that comprises a first range of assessment scores;
sending a first candidate assessment to a second device associated with a first candidate profile;
receiving, from the second device, first assessment data of the first candidate profile captured during the first candidate assessment;
generating a first assessment score associated with the first candidate profile from the first assessment data;
determining that the first candidate profile satisfies the first criteria by at least determining that the first range of assessment scores comprises the first assessment score;
responsive to determining that the first candidate profile satisfies the first criteria, placing, by the processing device, the first candidate profile in the first tier; and
sending, by the processing device, tiered assessment data comprising the first tier with the first candidate profile.

18. The computer-readable non-transitory storage medium of claim 17, wherein the executable instructions cause the processing device further to:
generating a second tier of the plurality of tiers with second criteria that comprises a second range of assessment scores;
sending to a third device a second candidate assessment associated with a second candidate profile;
receiving, from the third device, second assessment data of the second candidate profile captured during the second candidate assessment;
generating a second assessment score associated with the second candidate profile from the second assessment data;
determining that the second candidate profile satisfies the second criteria by at least determining that the second range of assessment scores comprises the second assessment score; and
responsive to determining that the second candidate profile satisfies the second criteria, placing the second candidate profile in the second tier,
wherein the tiered assessment data further comprises the second tier with the second candidate profile.

19. The computer-readable non-transitory storage medium of claim 18, wherein the executable instructions cause the processing device further to:
receiving third criteria comprising a requested attribute of a candidate;
determining that first candidate profile satisfies the third criteria by at least determining that the first candidate profile comprises the requested attribute, wherein the first candidate profile comprises one or more attributes of the first candidate; and
responsive to determining the first candidate profile comprises the requested attribute, removing the first candidate profile from the first tier and placing the first candidate profile in the second tier.

20. The computer-readable non-transitory storage medium of claim 17, wherein the executable instructions cause the processing device further to:
receiving status information related to the position;
responsive to receiving the status information, altering the first criteria by changing the first range of assessment scores to a second range of assessment scores wherein the second range of assessment scores is less inclusive that the first range of assessment scores;
determining the second range of assessment scores does not comprise the first assessment score; and
responsive to determining the second range of assessment scores does not comprise the first assessment score, removing the first candidate profile from the first tier.
